(19) United States
(12) Patent Application Publication
(10) Pub. No.: US 2011/0264824 A1
(43) Pub. Date: Oct. 27, 2011

(54) ENHANCEMENT TO SIP FORKING FOR IMPROVED USER SERVICES

(76) Inventors: Jayaraman Venkata Subramanian, Tamil Nadu (IN); Seetharaman Swaminathan, Tamil Nadu (IN)

(21) Appl. No.: 13/057,660

(22) PCT Filed: Aug. 8, 2008
(86) PCT No.: PCT/IB08/54470

§ 371 Date: Jul. 19, 2011

(51) Int. Cl. G06F 15/173

(52) U.S. Cl. 709/238

(57) ABSTRACT

A method of enhancing SIP forking for offering improved call services in a telecommunication network is disclosed. An endpoint of the network is assigned as a Forking Master for providing improved call services for a user in the same Address of Record (AoR) in the presence of forking. The method of assigning a forking master comprises of user provisioning, updating by the user terminal during registration, subsequent declaration by the user terminal, third-party assignment and network-triggered assignment. An endpoint can take up or relinquish the role of Forking Master by specifying the value ‘true’ or false' for the forking-master parameter. The Forking Master can be associated with call completion services, presence-based services, call- forwarding interaction, lawful interception, facilities like PBRT and the like.

### BACKGROUND

1. Technical Field

The embodiments disclosed herein generally relate to telecommunication, and, more particularly, to providing improved services to users of telecommunication networks.

2. Description of the Related Art

There exist several constraints/limitations in present IMS/SIP networks in offering enhanced services to the served users in the presence of forking. Usually, forked requests are not allowed for the call completion event package, for example, in call completion to a busy subscriber (CCBS). The SIP framework mandates that the event package should indicate whether or not forked SUBSCRIBE requests can install multiple subscriptions.

In IMS networks, a single queue is maintained for all endpoints of the called user if the CCBS procedures are handled at the network level and the call completion is attempted when any of the endpoints of called user becomes free though the endpoint may not be interested in call completion attempt. The problem can be solved by maintaining individual queues for each endpoint. However, the solution drastically increases the complexity of the solution using a lot of network resources and is also not scalable and manageable.

In case of SIP networks, the SUBSCRIBE requests with event package call completion is forwarded to the endpoint and any endpoint responding with a dialog-establishing response is monitored for the busy condition. This endpoint may not be interested in the call completion. However, with the current mechanism of forking, it is difficult and unmanageable to allow multiple subscriptions and/or to monitor all the endpoints associated with an Address of Record (AoR) for a single subscription for call completion. Further, the processing complexity and resource usage makes forking unscalable for multiple users.

Usually, the presence event package allows forking, but there exists problems in situations where forking is involved. For example, in a case where only a subset of presence data is to be subscribed or a specific User Agent requires handling of the presence related SUBSCRIBE requests. Then, a specific User Agent may be configured to respond to the SUBSCRIBE request and other User Agents may send an error response, for instance, a 489 Bad Event response, or a 202 response followed by a NOTIFY with the Subscription-State as “terminated” with the reason code “rejected”. However, the endpoints need to be re-configured frequently in situations where the User Agent that wants to handle the SUBSCRIBE request often changes. The limitations could apply in general to event packages and consequently to other features, for example, INVITE-initiated dialog event package.

In a case, where the user has three endpoints with forking active and any incoming SIP request is forked to all the endpoints, it is not possible to invoke CCBS by the calling user to an endpoint desired by called user though all the endpoints corresponding to called user is busy. For a situation where there are multiple endpoints associated with the same AoR for a served user, it would be desirable that only the preferred or selected User Agent is contacted even though forking is active. Further, the preference may change frequently making it impractical to hard-code.

In the present call services, the desired endpoint for call forwarding is not specifically monitored for free condition. A further drawback of conventional communication system is that indicating whether or not forking installs multiple subscriptions by event package does not guarantee flexible, convenient and enhanced services as desired by the end-user. Furthermore, it is not possible in today's SIP networks for only a certain endpoint to react to particular requests without any additional complexity, and message overheads in the presence of forking.

### SUMMARY

In view of the foregoing, an embodiment herein provides a method of handling improved call services by assigning at least one endpoint as a forking master in a communication network, the method comprising steps of provisioning by a user; updating by a user terminal during registration, declaring subsequently by the user terminal; assigning by a third-party; and performing a network-triggered assignment. A Forking Master is defined as the UA/end-point that would be contacted in case of services/features that have difficulty to work when forking is involved, or to offer new/enhanced services that are convenient to the user in practical situations. The communications network can be one of a Session Initiation Protocol (SIP)-based network or an Internet Protocol (IP) Multimedia Subsystem (IMS) network. In case of an IMS network, the method is performed by at least one of an Application Server (AS) and a Serving-Call Session Control Function (S-CSCF) of the user. In case of a SIP-based non-IMS IMS network, the actions performed by the AS/S-CSCF are typically performed by a SIP Proxy.

Embodiments herein further disclose a method of declaring an endpoint as a forking master by a user terminal, a third-party, or a network-trigger, the method comprising of sending an INVITE request, or sending a MESSAGE with a Contact URI where the Contact header fields include the parameter forking-master with a value true or false. The forking-master=true indicates an endpoint take over as a Forking Master and forking-master=false indicates that the existing Forking Master wants to relinquish the role of Forking Master. The endpoint can query the identity of the forking-master by sending a REGISTER or INVITE message. In case of REGISTER, the Contact header in the 200 OK response (to the Register) includes the Forking Master's identity, and in case of INVITE, the 200 OK's body includes the information of Forking Master. The network may inform the Forking Master's identity using INVITE or MESSAGE to all the endpoints.

Embodiments herein further disclose a system adapted to handle improved call services in a communication network, the system comprising at least one means adapted to assign at least one endpoint as a Forking master for providing call/communication services for an user in the same Address of Record (AoR) in the presence of forking.

Embodiments further disclose a system adapted to assign at least one endpoint as the forking master, the system comprising at least one means adapted to perform a user provisioning, user registration, subsequent declaration by the user terminal, third-party assignment and network-triggered embodiment. Further, the system includes at least one means adapted to perform query of the forking-masters identity by an endpoint. Moreover, the system includes at least one means adapted to promote informing of forking-master's identity to the endpoints by the communication network.

Embodiments further disclose a terminal, where the terminal comprises can act as a forking master; can invite a second terminal to act as forking master; and relinquish role of said forking master, when required.

These and other aspects of the embodiments disclosed herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments disclosed herein without departing from the spirit thereof, and the embodiments disclosed herein include all such modifications.

### BRIEF DESCRIPTION OF THE DRAWINGS

The embodiments disclosed herein will be better understood from the following detailed description with reference to the drawings, in which:

FIG. 1 is a block diagram showing an illustration of a network topology with the involved network elements in an IP Multimedia Subsystem (IMS) network, according to an embodiment herein;

FIG. 2 is a block diagram showing an illustration of a network topology with the involved network elements in a non-IMS Session Initiation Protocol (SIP) network, according to an embodiment herein;

FIG. 3 illustrates a schematic diagram illustrating the call flow for declaring the Terminal 1 of User A as the Forking Master during registration, according to an embodiment herein;

FIG. 4 illustrates a flowchart depicting a method of declaring the User A as the Forking Master during registration, according to an embodiment herein;

FIG. 5 illustrates a schematic diagram illustrating the call flow for declaration of Forking Master by the user terminal by sending an INVITE in a telecommunications network, according to an embodiment herein;

FIG. 6 illustrates a flowchart depicting a method of declaration of Forking Master by the user terminal by sending an INVITE in a telecommunications network, according to an embodiment herein;

FIG. 7 illustrates a schematic diagram depicting the call flow for declaration of Forking Master by the user terminal by sending a MESSAGE in a telecommunications network, according to an embodiment herein;

FIG. 8 illustrates a flowchart depicting a method of declaration of Forking Master by the user terminal by sending a MESSAGE in a telecommunications network, according to an embodiment herein;

FIG. 9 illustrates a schematic diagram depicting the call flow for network-triggered assignment of Forking Master by sending an INVITE in a telecommunications network, according to an embodiment herein;

FIG. 10 illustrates a flowchart depicting a method of network-triggered assignment of Forking Master by sending an INVITE in a telecommunications network, according to an embodiment herein;

FIG. 11 illustrates a schematic diagram depicting the call flow for querying the Forking Masters identity by sending an INVITE in a telecommunications network, according to an embodiment herein;

FIG. 12 illustrates a flowchart depicting a method of querying the Forking Masters identity by sending an INVITE in a telecommunications network, according to an embodiment herein;

FIG. 13 illustrates a schematic diagram depicting the call flow for querying the Forking Masters identity by sending a REGISTER in a telecommunications network, according to an embodiment herein;

FIG. 14 illustrates a flowchart depicting a method of querying the Forking Masters identity by sending a REGISTER in a telecommunications network, according to an embodiment herein;

FIG. 15 illustrates a schematic diagram depicting the call flow for informing the Forking Masters identity by sending an INVITE in a telecommunications network, according to an embodiment herein;

FIG. 16 illustrates a flowchart depicting a method of informing the Forking Masters identity by sending an INVITE in a telecommunications network, according to an embodiment herein;

FIG. 17 illustrates a schematic diagram depicting the call flow for informing the Forking Masters identity by sending a MESSAGE in a telecommunications network, according to an embodiment herein;

FIG. 18 illustrates a flowchart depicting a method of informing the Forking Masters identity by sending a MESSAGE in a telecommunications network, according to an embodiment herein; and

FIG. 19 is a schematic diagram showing an exemplary illustration, of the use of Forking Master in a normal SIP network, according to an embodiment herein.

### DETAILED DESCRIPTION OF PREFERRED EMBODIMENTS

The embodiments disclosed herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments disclosed herein. The examples used herein are intended merely to facilitate an understanding of ways in which the embodiments disclosed herein may be practiced and to further enable those of skill in the art to practice the embodiments disclosed herein. Accordingly, the examples should not be construed as limiting the scope of the embodiments disclosed herein.

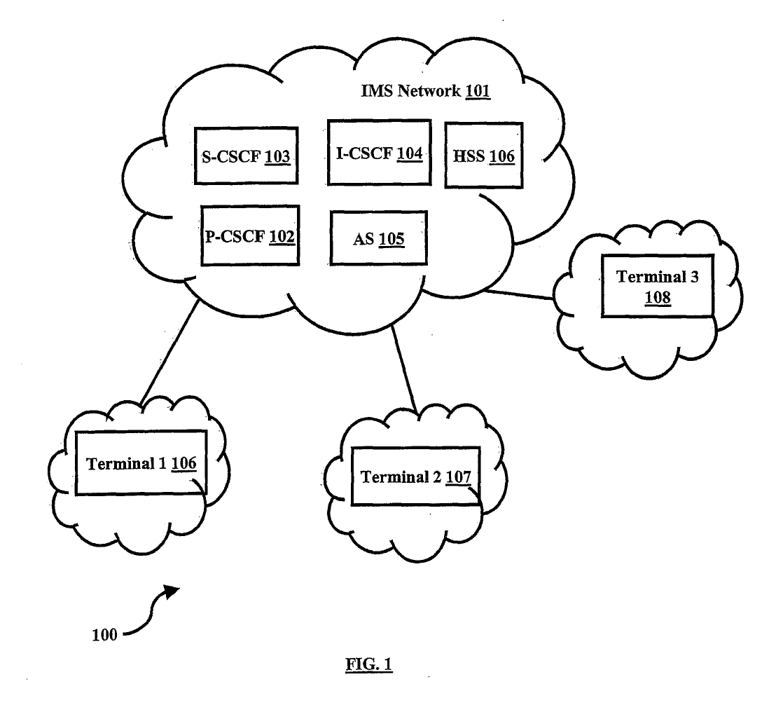

Embodiments herein disclose a method to enhance SIP forking for offering new/improved services/features for served users by assigning a Forking Master. The concept of Forking Master provides a dynamic possibility to address a particular endpoint for certain services and not simply fork a (SIP) request, even when forking is active for the AoR present in the ‘To’ of the (SIP) request message. Referring now to the drawings, and more particularly to FIGS. 1 through 19, where similar reference characters denote corresponding features consistently throughout the figures, there are shown preferred embodiments.

A “Forking Master” is a User Agent or endpoint that can be contacted in case of services/features that have difficulty to work when forking is involved, or to offer new or enhanced services that are convenient to the user in practical situations. Forking Master can be assigned by methods such as provisioning, registration of a user terminal, declaration by an endpoint, third-party assignment and network triggered assignment. Forking Master offers services or features such as call completion services, Presence-Based services, call forwarding interaction, lawful interception, facilities like Personalized Ring Back Tone (PRBT) and the like that are difficult to perform in the presence of forking in IP Multimedia Systems (IMS)/Session Initiation Protocol (SIP) networks.

FIG. 1 is a block diagram showing an illustration of a network topology with the involved network elements in an IP Multimedia Subsystem (IMS) network, according to an embodiment herein. The IP multimedia subsystem (IMS) network 101 comprises a number of network elements, such as Proxy Call-Session Control Function (P-CSCF) 102, Serving-Call Session Control Function (S-CSCF) 103, Interrogating-Call Session Control Function (I-CSCF) 104, Application server (AS) 105 and Home Subscriber Server (HSS) 106. The P-CSCF 102 provides interface between the IMS network 101 and user terminals say terminal 1 106, terminal 2 107, and terminal 3 108 and provides IP addresses and other variables to establish IP sessions. The S-CSCF 103 provides session control for subscribers accessing call services within an MS network 101. All Forking Master related SIP requests and responses are sent to the AS 105. The S-CSCF 103 performs the initial filter criteria by examining the Contact header and/or message body and sends a request to the AS 105 addressed to a user for whom the forking master is active. The AS 105 hosts and executes services, and interfaces with the S-CSCF 103 using Session Initiation Protocol (SIP). The AS 105 updates the user profile regarding the Forking Master indications in the received SIP request/response message and also informs the HSS 106 using the standard Sh interface of IMS. Subsequently, the S-CSCF 103 is also informed of the update using the standard Cx interface to the initial filter criteria arising from the updates to the user profile related to the Forking Master. The HSS 106 is the user database which includes the user profiles and performs authentication and authorization of the calling users. The services that are dependent or have interaction with forking-master are stored in the HSS, if such services are provisionable either at a network level or at a user level. The service logic after examination of the subscriber profile may be taken by AS 105 in an IMS network 101. This function of the AS can also be handled in the terminating S-CSCF in IMS. The terminating AS/S-CSCF refers to the network element corresponding to the user for whom the Forking Master is active.

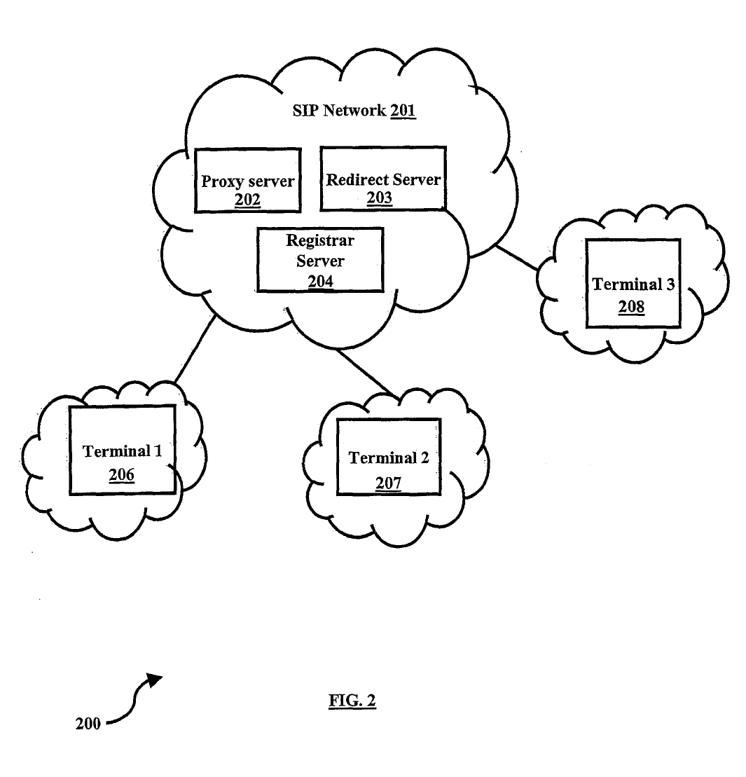

FIG. 2 is a block diagram showing an illustration of a network topology with the involved network elements in a non-IMS Session Initiation Protocol (SIP) network 201, according to an embodiment herein. SIP is an application-layer control protocol used to establish, maintain, and terminate calls between two or more end points. The SIP network 201 comprises of SIP servers and SIP clients. The SIP network 201 includes the proxy server 202, redirect server 203, and registrar sever 204 and the SIP clients include phone terminals, terminal 1 206, terminal 2 207, and terminal 3 208. The functions of SIP Proxy server 202 are similar to the actions performed by the AS 105 for IMS network 101 from the point of view of this invention. Proxy server 202 handles forking master assignment requests, triggering network-initiated Forking Master assignment, responding to the query of the Forking Masters identity, informing the Forking Masters identity and modifying the requests to the user with Forking Master active. This line is not at all clear. The registrar server 204 accepts and processes REGISTER request from users and places the information into the location service for the domain it handles. The SIP registrar server 204 stores the data related to Forking Master similar to the functions of HSS 106 for an IMS network 101. Registrar server 204 is often co-located with a redirect server 203 or proxy server 202.

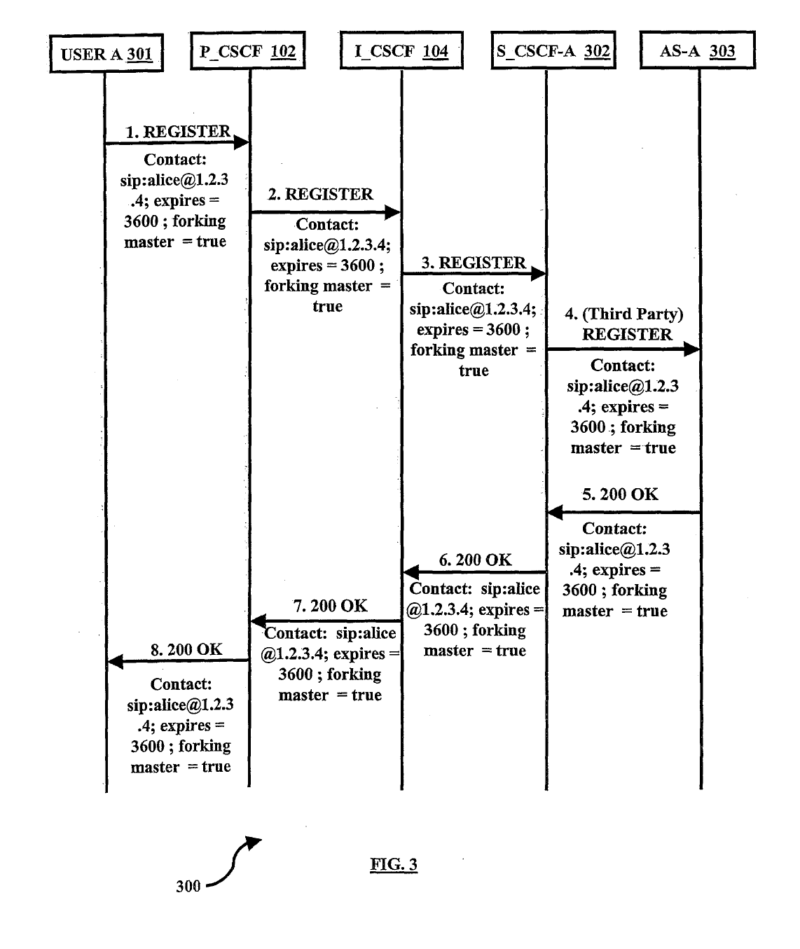

FIG. 3 illustrates a schematic diagram illustrating the call flow for declaring the Terminal 1 of User A as the Forking Master during registration, according to an embodiment herein. The served IP multimedia subsystem (IMS) User A 301 assigns an end-point (say, Terminal 1) as Forking Master by introducing a parameter “forking-master” in the Contact header field of the REGISTER message. The parameter “forking-master” can take the value true or false depending on whether the end-point wants to take up the role of or relinquish the role of Forking Master. The assignment of Forking Master by self-declaration (or by third-party assignment) is specified only for certain duration. Once the duration is expired, the default Forking Master specified in the user profile takes over the role of the Forking Master. An additional parameter “expires” can be introduced to indicate the duration of the Forking Master assignment. When the parameter expires is used, the Forking Master indication has to be in the message body (and not a part of the Contact header) to avoid confusion with the use of the ‘expires’ in the Contact header. The User A 301 sends a REGISTER message with a parameter “forking-master”=true in the Contact header field to P_CSCF 102. The P_CSCF 102 sends the REGISTER to I-CSCF-A 104, which then forwards the REGISTER to S_CSCF-A 302 (after determining to which S-CSCF the REGISTER has to be forwarded to) which then sends the REGISTER to AS-A 303. The AS-A 303 updates the user profile and informs HSS 106 via Sh interface and HSS 106 subsequently informs the updates to S_CSCF-A 302 via the Cx interface. The AS-A 303 then sends a 200 OK back to S_CSCF-A 302. The S_CSCF-A 302 then sends 200 OK to P_CSCF 102 via the I-CSCF 104. The P-CSCF 102 then sends the 200 OK to User A 301. The Forking Master is active and is used by the S_CSCF-A 302/AS-A 303 for relevant services.

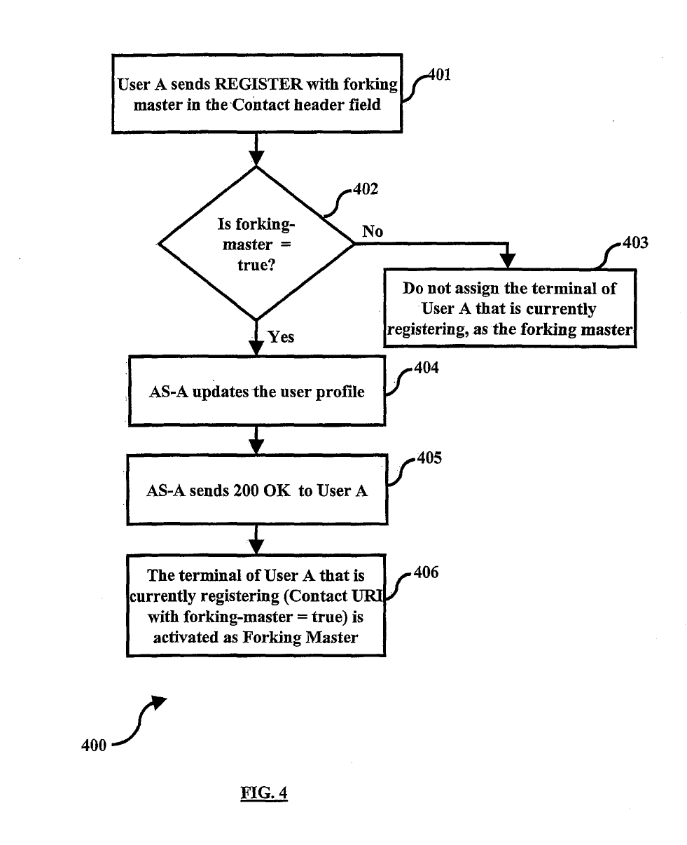

FIG. 4 illustrates a flowchart depicting a method of declaring the User A as the Forking Master during registration, according to an embodiment herein. User A 301 sends (401) a REGISTER message with a parameter forking-master in the Contact header field to S_CSCF-A 302 (via the P-CSCF 102 and I-CSCF 104) and subsequently to AS-A 303. AS-A 303 then checks (402) if forking-master is true for the endpoint in the REGISTER message. If forking-master is true, then AS-A 303 updates (404) the user profile and sends (405) a 200 OK back to User A 301. The terminal of User A 301 that is currently registering with the forking-master=true indication is then activated (406) as the Forking Master and used by the S_CSCF-A 302 or AS-A 303 for preferred services. If forking-master parameter in the REGISTER message is false, then do not assign (403) the terminal of User A 301 (that is currently registering with the forking-master=false indication) as the Forking Master, and if this terminal was earlier the Forking Master, deactivate it as the Forking Master, and activate the default Forking Master (in User A's—user profile) as the new Forking Master. The various actions in method 400 may be performed in the order presented, in a different order, or simultaneously. Further, in some embodiments, some actions listed in FIG. 4 may be omitted.

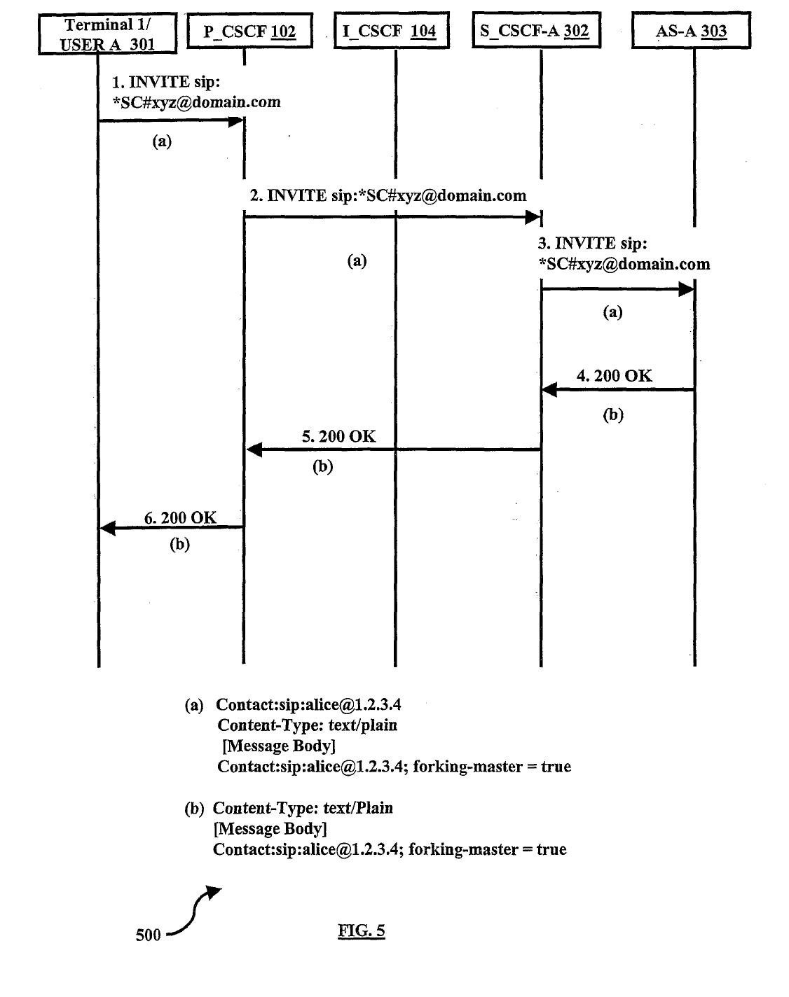

FIG. 5 illustrates a schematic diagram illustrating the call flow for declaration of Forking Master by the user terminal by sending an INVITE in a telecommunications network, according to an embodiment herein. An endpoint (say Terminal 1) of the served IMS user User A 301 declares itself or any other endpoint as Forking Master, after the registration of the user/terminal is completed. User A 301 sends an INVITE message with a special service code in the Request URI/To header field with the Contact URI including the parameter forking-master=true to P-CSCF 102 which is then sent subsequently to S_CSCF-A 302 and then to AS-A 303. The forking-master=true indication may also be included in the message body (Content-Type: text/plain). The forking-master parameter can take the value true or false. Forking Master=true indicates that the Contact URI takes over the functions of Forking Master. Forking-master=false indicates that the Contact URI relinquishes the functioning of Forking Master. The AS-A 303 then sends a 200 OK to S_CSCF-A 302 which is then sent to User A 301 via the P-CSCF 102, as an acknowledgement that the Forking Master is updated. The Forking Master is active and can be appropriately used for relevant services. In another aspect, a 200 OK response conveys the Forking Master information in the message body in case of self-declaration as well as in case of third-party assignment with Content-Type as text/plain. The I-CSCF 104 is mainly used to establish the S-CSCF which is in use and may or may not be involved in the remaining call flow.

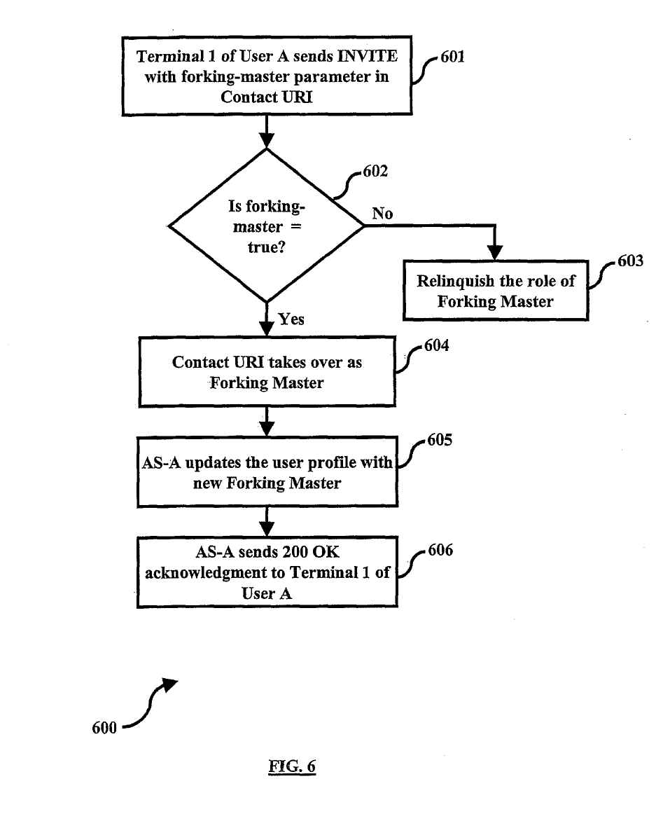

FIG. 6 illustrates a flowchart depicting a method of declaration of Forking Master by the user terminal by sending an INVITE in a telecommunications network, according to an embodiment herein. Terminal 1 106 of User A 301 sends (601) an INVITE with a parameter Forking Master in the Contact header field which reaches S_CSCF-A 301, and subsequently AS-A 303. AS-A 303 then checks (602) if the value of forking-master is true or not in the INVITE message. If forking-master is true, then Contact URI takes (604) over as the Forking Master. AS-A 303 then updates (605) the user profile of User A 301 with the new Forking Master and sends (606) a 200 OK back to User A 301, via the S-CSCF 302 and P-CSCF 102, as an acknowledgement that the Forking Master is updated. The Forking Master is activated and used by the S_CSCF-A/AS-A 303 for preferred services. If the value of Forking Master in INVITE is false, then the Terminal 1 106 of User A wants to relinquish (603) the role of Forking Master. AS A 303 then updates the user profile accordingly, and take appropriate actions subsequently, for example, the default Forking Master as specified in the user profile becomes the Forking Master, trigger the update of Forking Master to all terminals of User A, and the like. The scenario illustrated here is the self-assignment, as in the case of third-party assignment of Forking Master, the Forking Master's identity should be specified in the body of the INVITE message as described in FIG. 5. The various actions in method 600 may be performed in the order presented, in a different order, or simultaneously. Further, in some embodiments, some actions listed in FIG. 6 may be omitted.

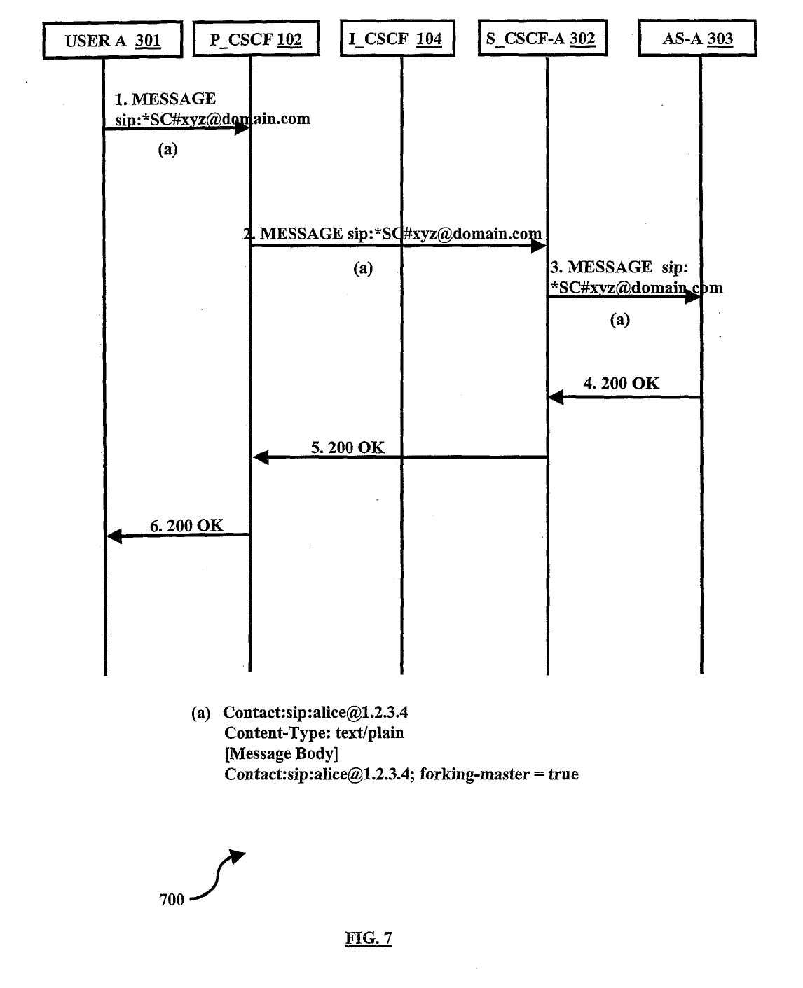

FIG. 7 illustrates a schematic diagram depicting the call flow for declaration of Forking Master by the user terminal by sending a MESSAGE in a telecommunications network, according to an embodiment herein. An endpoint (say Terminal 1) of the served IMS user User A 301 declares itself or any other endpoint as Forking Master, after the registration of the user is completed. Terminal 1 106 of User A 301 sends a MESSAGE with a special service code in the Request URI/To header field with the message body (Content-Type: text/plain) including the parameter forking-master=true to P-CSCF 102 which subsequently reaches S_CSCF-A 302 and then AS-A 303. The AS-A 303 then sends a 200 OK to S_CSCF-A 302 which finally reaches User A 301, as an acknowledgement that the Forking Master is updated. The Forking Master is active and can be appropriately used for relevant services. Note that in accordance with RFC 3428, the 200 OK response to MESSAGE cannot include the Contact header or the message body. The explicit indication that the Forking Master update was indeed successful would not be possible in case of INVITE. But 200 OK can be sent by the AS-A 303 only in case of successful update of the Forking Master.

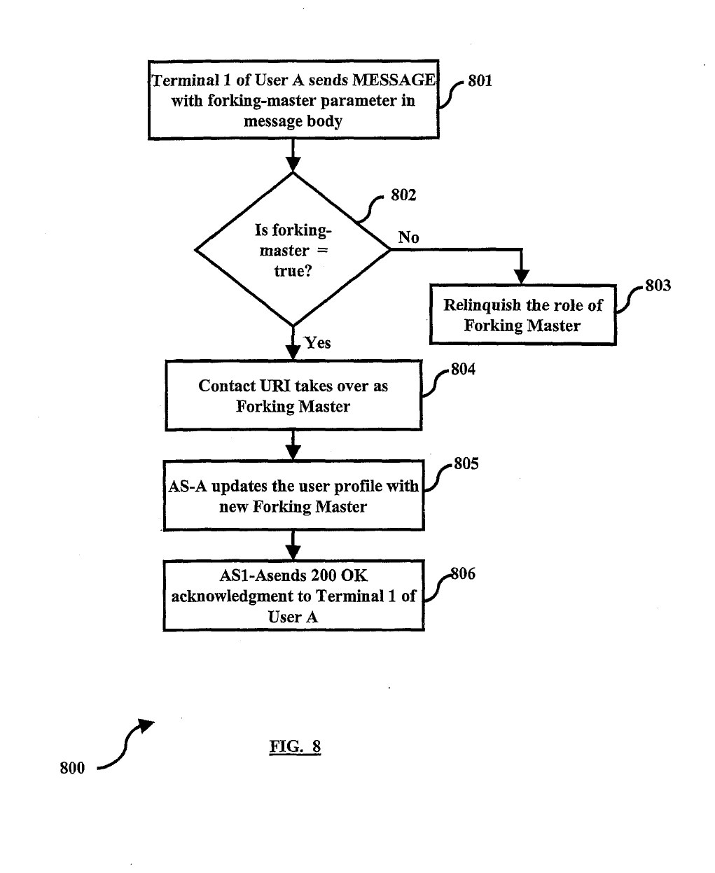

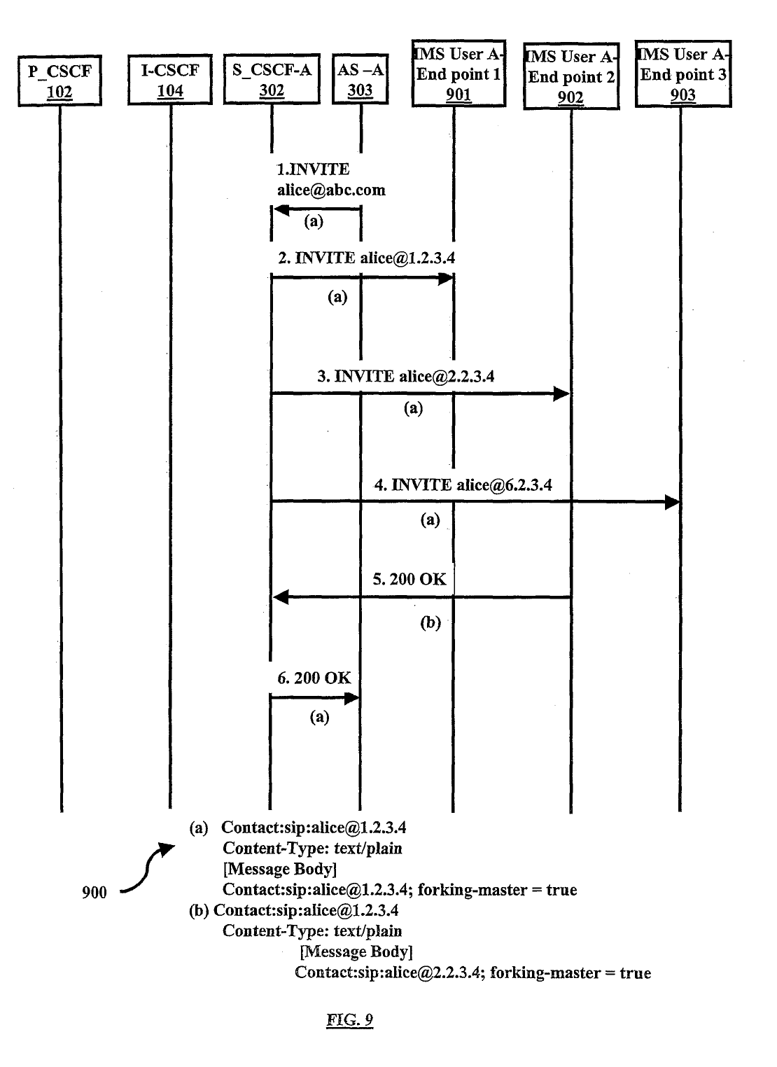

FIG. 8 illustrates a flowchart depicting a method of declaration of Forking Master by the user terminal by sending MESSAGE in a telecommunications network, according to an embodiment herein. Terminal 1 106 of User A 301 sends (801) a MESSAGE with a parameter forking-master in the message body (Content-Type: text/plain) which reaches S_CSCF-A 302 and subsequently AS-A 303. The contents of the message body are indicated in FIG. 9. AS-A 303 then checks (802) if the value of forking-master is true or not in MESSAGE. If forking-master is true, then Contact URI takes (804) over as the Forking Master. AS-A 303 then updates (805) the user profile of User A 301 with the new Forking Master and sends (806) a 200 OK back, which finally reaches Terminal 1 106 of User A 301, via the S-CSCF 302 and P-CSCF 102, as an acknowledgement that the Forking Master is updated. The Forking Master is activated and used by the S_CSCF-A/AS-A 303 for preferred services. If the value of Forking Master in MESSAGE is false, then the endpoint sending the MESSAGE relinquishes (803) the role of Forking Master. AS A 303 then updates the user profile of User A 301 accordingly, and takes appropriate actions subsequently, for example, the default Forking Master as specified in the user profile becomes the Forking Master, trigger the update of Forking Master to all terminals of User A, etc. The scenario illustrated here is the self-assignment, as in the case of third-party assignment of Forking Master, the Forking Master's identity should be specified in the body of the MESSAGE. The various actions in method 800 may be performed in the order presented, in a different order, or simultaneously. Further, in some embodiments, some actions listed in FIG. 8 may be omitted.

FIG. 9 illustrates a schematic diagram depicting the call flow for network-triggered assignment of Forking Master by sending an INVITE in a telecommunications network, according to an embodiment herein. An IMS network 101 may trigger the assignment of Forking Master in certain situations as the Forking Master has no provisioned value in the user profile, a provisioned value exists but a new endpoint with same AoR registers, or a periodic trigger, for example, depending on the time of the day, to check the correctness of the assignment of Forking Master. The AS-A 303 sends INVITE request to the registered endpoints, endpoint 1 901, endpoint 2 902, and endpoint 3 903 of User A 301 via the S CSCF-A 302. If AS-A 303 is aware of the contact information of specific endpoints that are registered, then AS-A 303 may also send INVITE request to those endpoints. The content in INVITE includes Content-Type: text/plain indicating a request for assigning a new Forking Master by specifying the following the message body: assign-forking-master<Contact URI>; Forking Master=true (indicates the current Forking Master). If Forking Master=none, then no Forking Master is currently assigned. An additional parameter can be optionally introduced in the content to indicate the status such as active, not registered, and the like of the currently assigned Forking Master. The endpoint 2 902 sends back a 200 OK declaring itself as the Forking Master to S_CSCF-A 302 which then reaches AS-A 303. Generally, only one endpoint replies with 200 OK informing the acceptance of role of Forking Master or relinquish the role if it is currently the Forking Master. This can be indicated by including in the 200 OK response, the forking-master parameter in the Contact header (typically in case of self-declaration), or in the message body (Content-Type: text/plain) with the syntax similar to the case of declaration of Forking Master by user terminal (for example, as in FIG. 5). Once 200 OK is accepted, it is acknowledged with an ACK, and a CANCEL is sent to the other endpoints to which INVITE was sent. The Forking Master is activated and can be appropriately used for relevant services. The indication of forking-master may be included as a part of the Contact header of the 200 OK response as endpoint 2 902 performs self-declaration of Forking Master. In case if multiple endpoints responds with 200 OK, the 200 OK to be accepted may be determined based on the first 200 OK with forking-master information, or based on some other criteria such as authorization. If none of the 200 OKs contain any indication regarding the Forking Master (either in the Contact header, or in the message body), or if no endpoints respond with information regarding the Forking Master, then any of the endpoints can decide to take up the role of Forking Master or to relinquish the role of the Forking Master using subsequent declaration by the user terminal as Forking Master or third-party assignment of Forking Master.

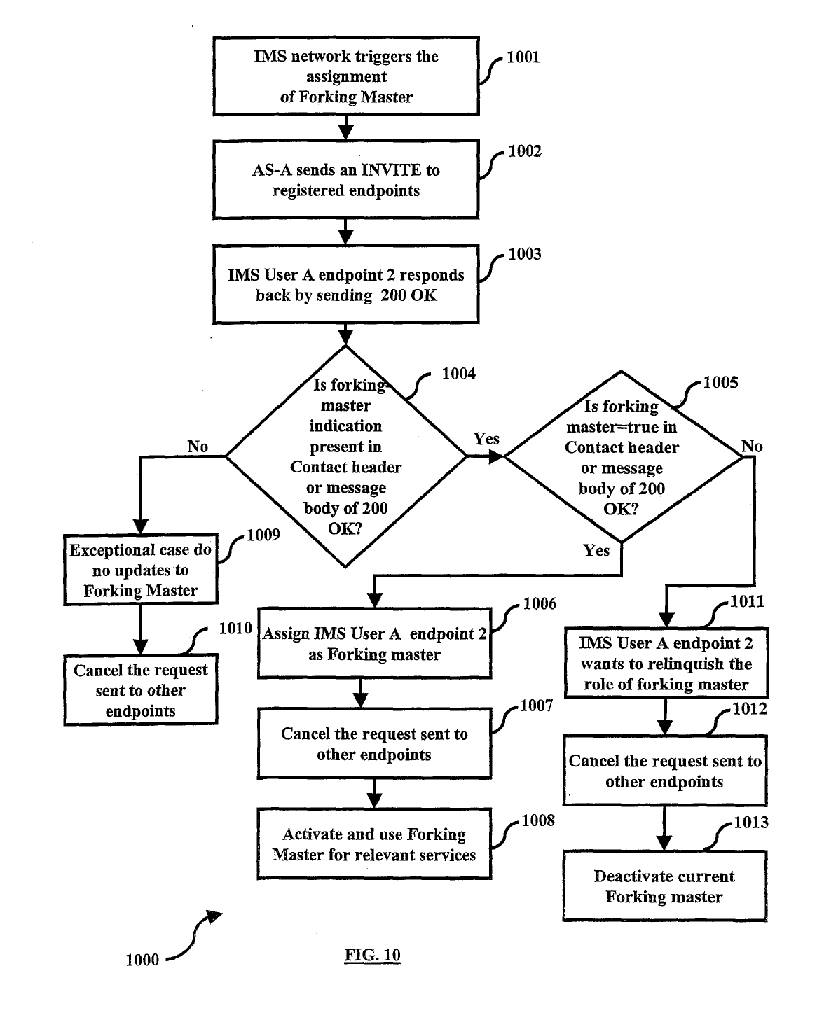

FIG. 10 illustrates a flowchart depicting a method of network-triggered assignment of Forking Master by sending an INVITE in a telecommunications network, according to an embodiment herein. The IMS network 101 triggers (1001) the assignment of Forking Master by the AS-A 303 sending (1002) an INVITE request to the registered endpoints endpoint 1 901, endpoint 2 902, and endpoint 3 903 of User A 303. The content in INVITE includes Content-Type: text/plain indicating a request for assigning a new Forking Master by specifying the following the message body: assign-forking-master<Contact URI>; Forking Master=true (indicating the current Forking Master). The endpoint 2 902 responds (1003) to the INVITE message by sending back a 200 OK to AS-A 303 informing the acceptance of the role of Forking Master by indicating forking-master parameter as true in either the Contact header or in the message body of the 200 OK. When including the Forking Master info in the message body of the 200 OK, the format “<Contact URI>; forking-master=<true/false>” can be used for both self-declaration and as third-party assignment. The AS-A 303 checks (1004) if the parameter forking-master is present in the 200 OK response, in the Contact header or in the message body of the 200 OK response. If forking-master is not present, then the AS-A 303 does not perform (1009) any updates to the Forking Master and cancels (1010) the INVITE request sent to other endpoints. Additionally, AS-A 303 can possibly send a new INVITE again, as described in step 1002. If the parameter forking-master is present in the 200 OK response, AS-A 303 then checks (1005) if the parameter forking-master is true or false in the Contact header or in the message body of the 200 OK response. If the forking-master parameter is false, then the endpoint 2 902 wants to relinquish (1011) the role of forking master if the endpoint 2 902 is currently the Forking Master (assuming that the Contact URI specified in the message body of the 200 OK is that of endpoint 2 902). Further, AS-A 303 cancels (1012) the INVITE request sent to other endpoints, and deactivates (1013) the current Forking Master. If the forking-master is true, then assign (1006) endpoint 2 902 as Forking Master. The AS-A 303 then cancels (1007) the INVITE request sent to other endpoints. The endpoint 2 902 is activated (1008) as the Forking Master and is used by AS-A 303 for relevant services. In the illustration, the self-declaration of endpoint 2 1102 is assumed, however, it is possible that endpoint 2 1102 also performs third-party assignment. Further, when an endpoint is relinquishing the role of Forking Master (by sending the 200 OK with forking-master indication as false), a second (new) INVITE may be sent from AS-A (303) to request for the assignment of a new Forking Master. The various actions in method 1000 may be performed in the order presented, in a different order, or simultaneously. Further, in some embodiments, some actions listed in FIG. 10 may be omitted.

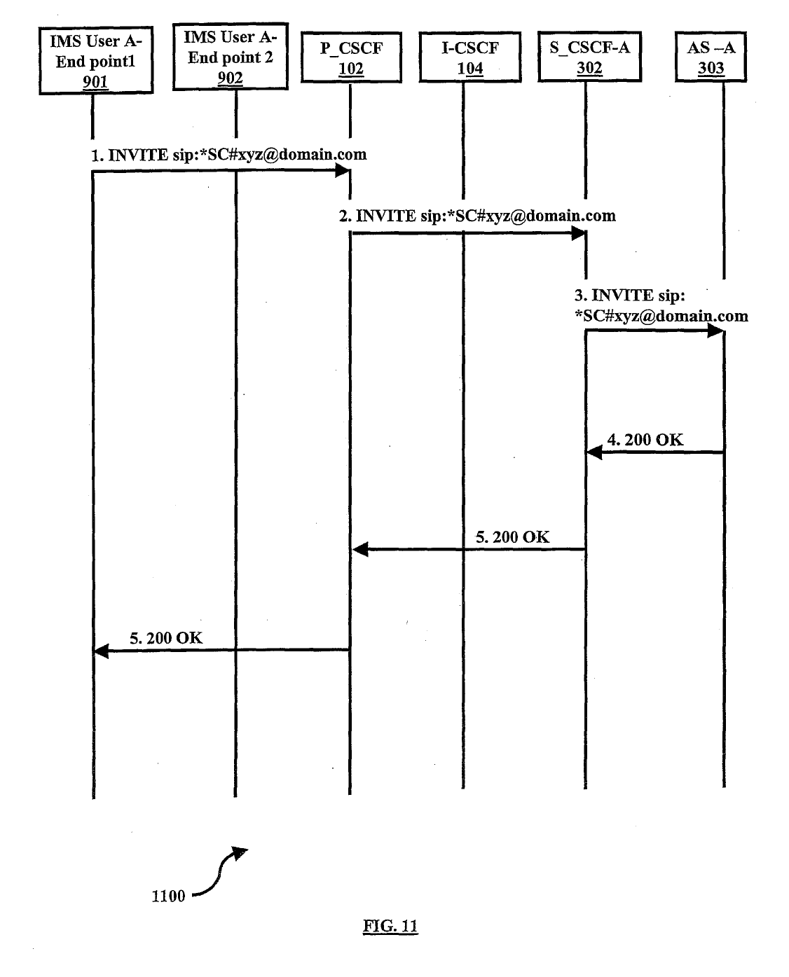

FIG. 11 illustrates a schematic diagram depicting the call flow for querying the Forking Masters identity by sending an INVITE in a telecommunications network, according to an embodiment herein. An endpoint of a forked IMS user wants to query to determine the current Forking Masters identity. For example, a mobile user registering with the same AoR with which a number of devices are registered and the mobile phone user needs to take over as Forking Master, which is possible if the mobile user is already not the Forking Master and hence the endpoints need to query the identity of the Forking Master. The User A 301 has 2 endpoints endpoint 1 901 and endpoint 2 902 corresponding to it. The endpoint 1 901 sends an INVITE to the AS-A 303 with the content (content-type: text/plain) in the message body: query-forking-master. The INVITE message can also be sent to a special URI with a service code, for example, *SC# in the request URI. The URI informs that the request is a Forking Master query and query-forking-master need not be inserted in the message body. The AS-A 303 sends a 200 OK in response to the INVITE to User A 301 endpoint 1 901, containing the identity of the Forking Master as Content-type: text/plain, <contact URI>; forking-master=true in the message body. In the case the Contact URI, alice@2.2.3.4 is the current Forking Master, the message body of the 200 OK would typically contain: “Contact: alice@2.2.3.4; forking-master=true”. The 200 OK is then accepted and acknowledged. If the 200 OK response has no content in the message body and if the <Contact URI>is none, then there is no Forking Master currently.

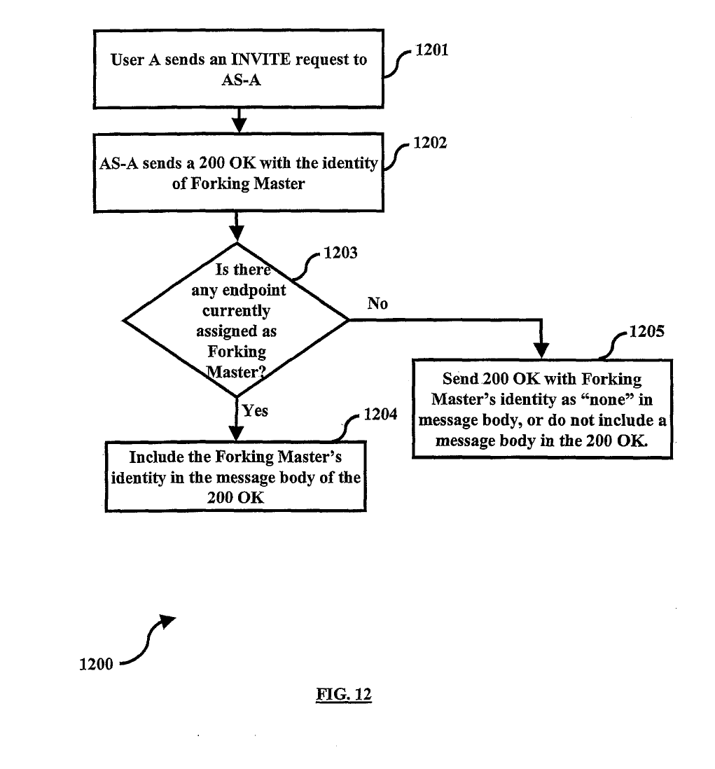

FIG. 12 illustrates a flowchart depicting a method of querying the Forking Masters identity by sending an INVITE in a telecommunications network, according to an embodiment herein. The endpoint 1 901 of User A 301 sends (1201) an INVITE request with a special service code to a particular URI. The AS-A 303 sends (1202) a 200 OK response to the INVITE containing the identity of the Forking Master in the message body. Further, check (1203) if the parameter forking-master=true for any of the current endpoints. If Forking Master=true, then send the 200 OK response (1204) with the identity of the forking master included in the message body (along with the indication forking-master=true for that Contact URI). If there us no endpoint currently acting as the Forking Master, then send the 200 OK response (1205), either with the message body indicating Contact URI of the forking-master as ‘none’, or without a message body at all. The various actions in method 1200 may be performed in the order presented, in a different order, or simultaneously. Further, in some embodiments, some actions listed in FIG. 12 may be omitted.

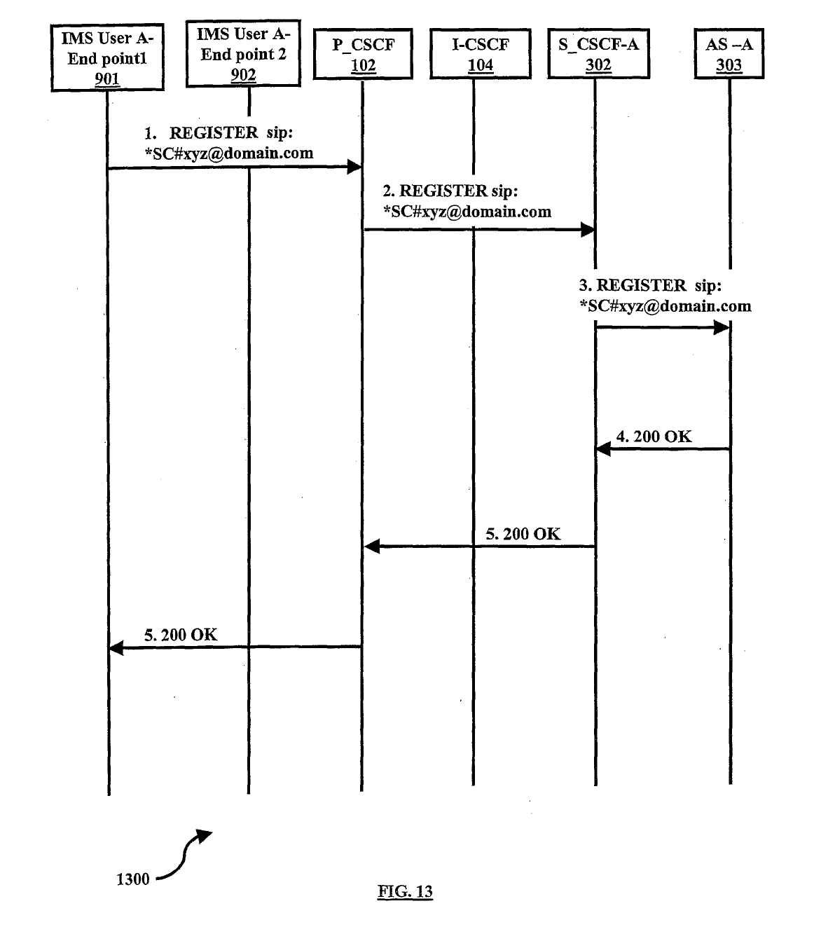

FIG. 13 illustrates a schematic diagram depicting the call flow for querying the Forking Masters identity by sending a REGISTER in a telecommunications network, according to an embodiment herein. The endpoint 1 901 sends a REGISTER request with no Contact header to fetch the list of current bindings to the AoR. The REGISTER reaches the AS-A 303 (via the S-CSCF-A), which then sends a 200 OK in response to the REGISTER to User A 301 endpoint 1 901 (via the S-CSCF-A) with the Contact header field containing the identity of the current Forking Master by setting the parameter forking-master=true for the URI currently acting as the Forking Master. The 200 OK is then accepted and acknowledged. If the parameter forking-master=true is not present for any of the bindings, then there is no endpoint currently acting as Forking Master.

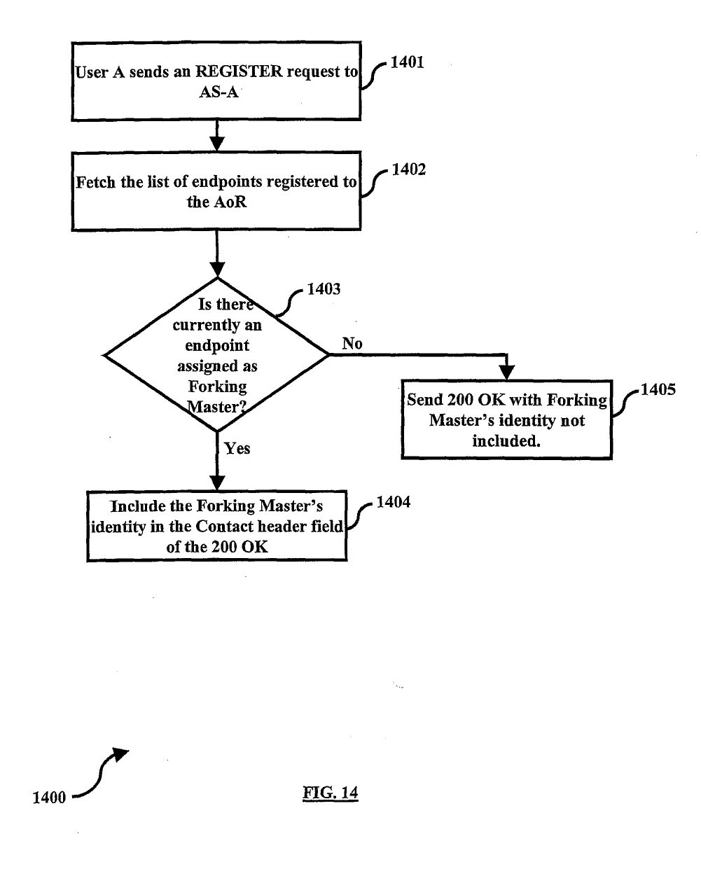

FIG. 14 illustrates a flowchart depicting a method of querying the Forking Masters identity by sending a REGISTER in a telecommunications network, according to an embodiment herein. The endpoint 1 901 sends (1401) a REGISTER request without any Contact header to fetch (1402) the list of current endpoints registered to the AoR. The REGISTER request reaches the AS-A 303 finally. The AS-A 303 checks (1403) if the any of the registered endpoints is acting as the Forking Master currently, and if yes, then include (1404) the Forking Master's identity in the Contact header field, by including the parameter forking-master=true for the URI that is the current Forking Master. If there is no endpoint currently acting as the Forking Master, then the AS-A 303 sends (1405) the 200 OK response to the REGISTER without any indication of the Forking Master. The various actions in method 1400 may be performed in the order presented, in a different order, or simultaneously. Further, in some embodiments, some actions listed in FIG. 14 may be omitted.

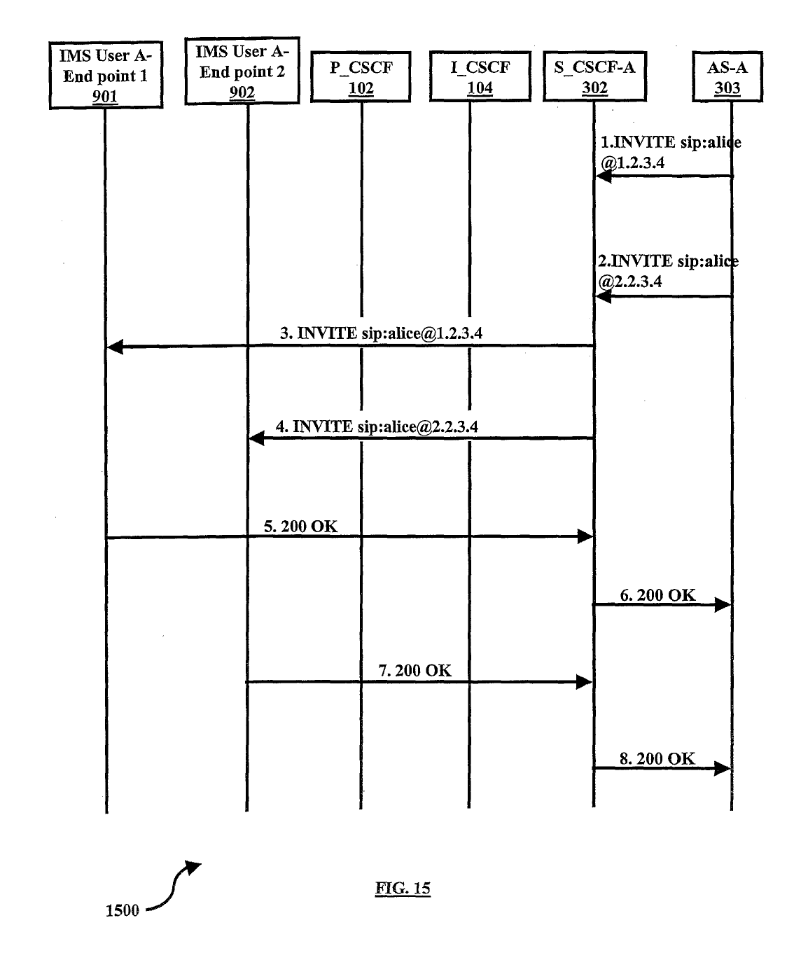

FIG. 15 illustrates a schematic diagram depicting the call flow for informing the Forking Masters identity by sending an INVITE message in a telecommunications network, according to an embodiment herein. The IMS network 101 informs all endpoints of the current assignment of Forking Master without the user performing any query. AS-A 303 sends the INVITE to S-CSCF-A 302 with the Request URI corresponding to User A 301 and S_CSCF-A 302 forks the INVITE to the different endpoints of User A 301, endpoint 1 901 and endpoint 2 902. The INVITE contains Content-Type: text/plain, and in the message body, includes the identity of the Forking Master in the format “Contact<URI>; forking-master=true”. The endpoint 1 901 and endpoint 2 902 responds to INVITE with a 200 OK to S_CSCF-A 302 and subsequently to AS-A 303. The method can also be used to inform the endpoints that the endpoint acting as Forking Master has relinquished the role, and there is no Forking Master active currently. In this case, the <URI> parameter in the Contact <URI> (in the message body of the INVITE) contains the value none.

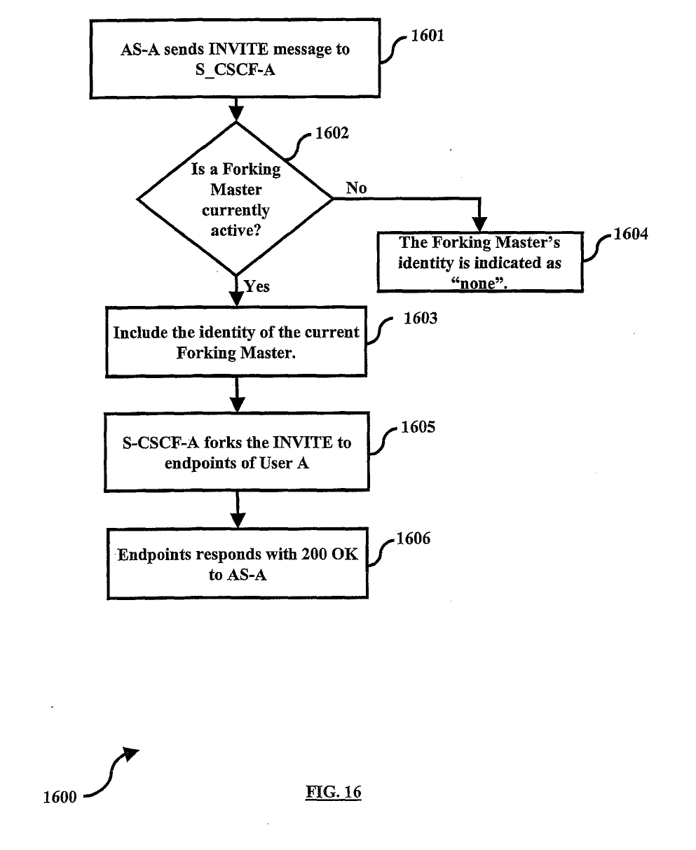

FIG. 16 illustrates a flowchart depicting a method of informing the Forking Masters identity by sending an INFO message in a telecommunications network, according to an embodiment herein. AS-A 303 sends (1601) an INVITE message to S_CSCF-A 302 with the Request URI corresponding to User A. The INVITE contains Content-Type:text/plain, and in the message body, includes the identity of the Forking Master in the format “Contact<URI>; forking-master=true”. The AS-A 303 checks (1602) whether a Forking Master is currently active. If yes, then the <URI> parameter in the “Contact <URI>” in the message body contains (1603) the identity of the Forking Master, otherwise the Contact<URI> value may be “none” (1604). The Contact<URI>=none is used to inform that an endpoint has relinquished its role of Forking Master, and so there is currently no Forking Master assigned. Further, SCSCF-A forks (1605) the INVITE to different endpoints say endpoint 1 901 and endpoint 2 902. The endpoint 1 901 and endpoint 2 902 responds (1606) with a 200 OK to AS-A 303. The various actions in method 1600 may be performed in the order presented, in a different order, or simultaneously. Further, in some embodiments, some actions listed in FIG. 16 may be omitted.

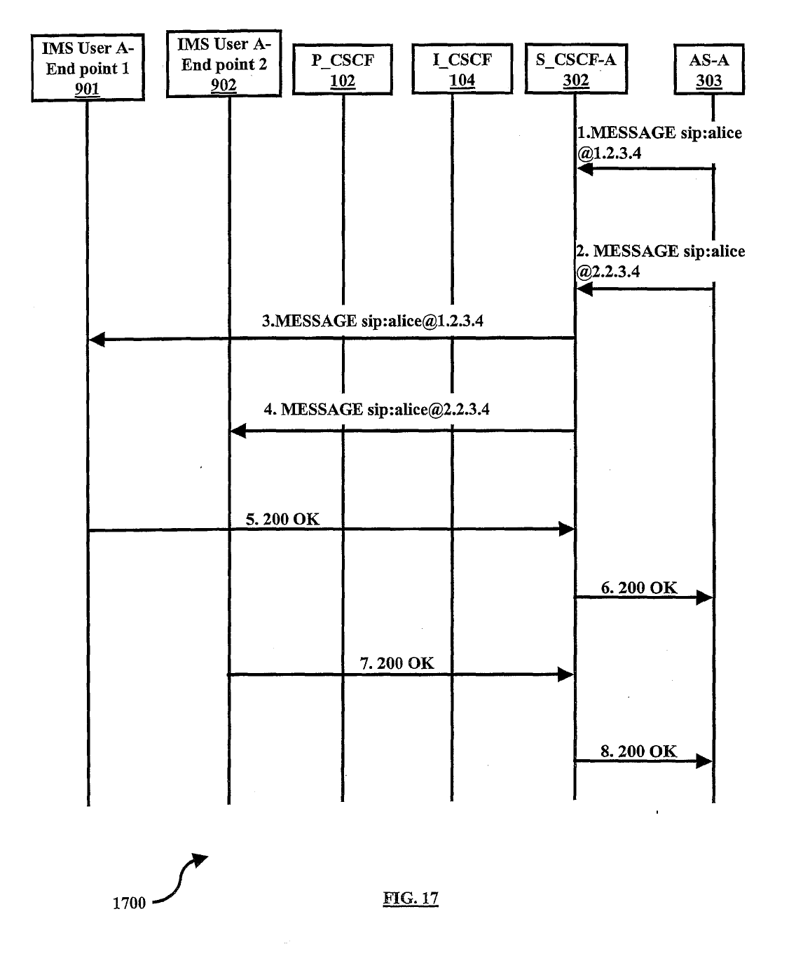

FIG. 17 illustrates a schematic diagram depicting the call flow for informing the Forking Masters identity by sending a MESSAGE in a telecommunications network, according to an embodiment herein. The IMS network 101 informs all endpoints of the current assignment of Forking Master without the user performing any query. AS-A 303 sends the MESSAGE to S-CSCF-A 302 with the Request URI corresponding to User A 301 and S_CSCF-A 302 forks the MESSAGE to the different endpoints of User A 301, endpoint 1 901 and endpoint 2 902. The MESSAGE contains Content-Type: text/plain, and in the message body, includes the identity of the Forking Master in the format “Contact<URI>; forking-master=true”. The endpoint 1 901 and endpoint 2 902 responds to MESSAGE with a 200 OK to S_CSCF-A 302 and subsequently to AS-A 303. The method can also be used to inform the endpoints that the endpoint acting as Forking Master has relinquished the role, and there is no Forking Master active currently. In this case, the <URI> parameter in the Contact <URI> (in the message body of the MESSAGE) contains the value none.

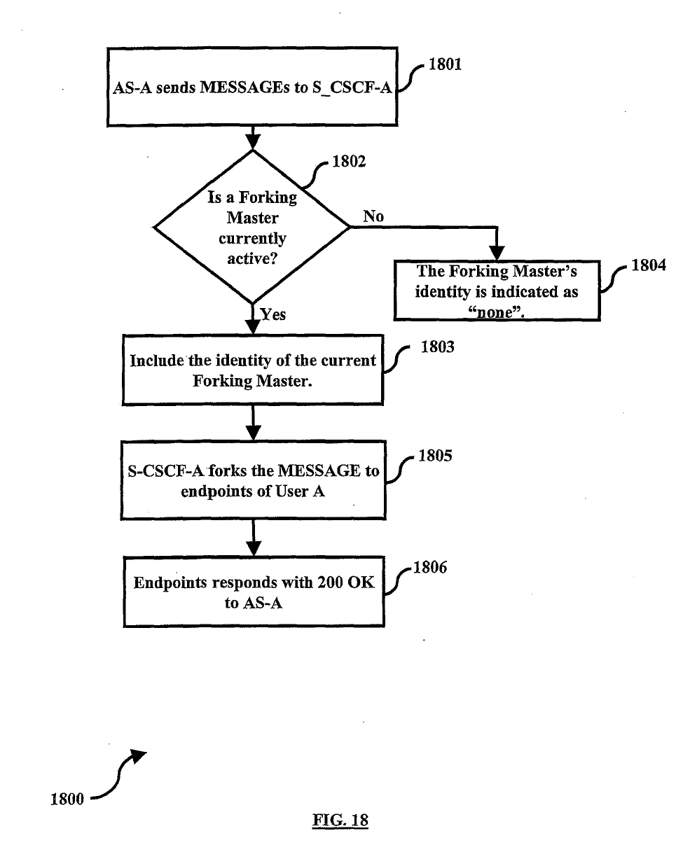

FIG. 18 illustrates a flowchart depicting a method of informing the Forking Masters identity by sending a MESSAGE in a telecommunications network, according to an embodiment herein. AS-A 303 sends (1801) a MESSAGE to S_CSCF-A 302 with the Request URI corresponding to User A. The AS-A 303 checks (1802) whether a Forking Master is currently active. If yes, then the <URI> parameter in the message body contains (1803) the identity of the Forking Master, otherwise the Contact<URI> value may be “none” (1804). Further, SCSCF-A forks (1805) the INVITE to different endpoints say endpoint 1 901 and endpoint 2 902. The endpoint 1 901 and endpoint 2 902 responds (1806) with a 200 OK to AS-A 303. The various actions in method 1800 may be performed in the order presented, in a different order, or simultaneously. Further, in some embodiments, some actions listed in FIG. 18 may be omitted.

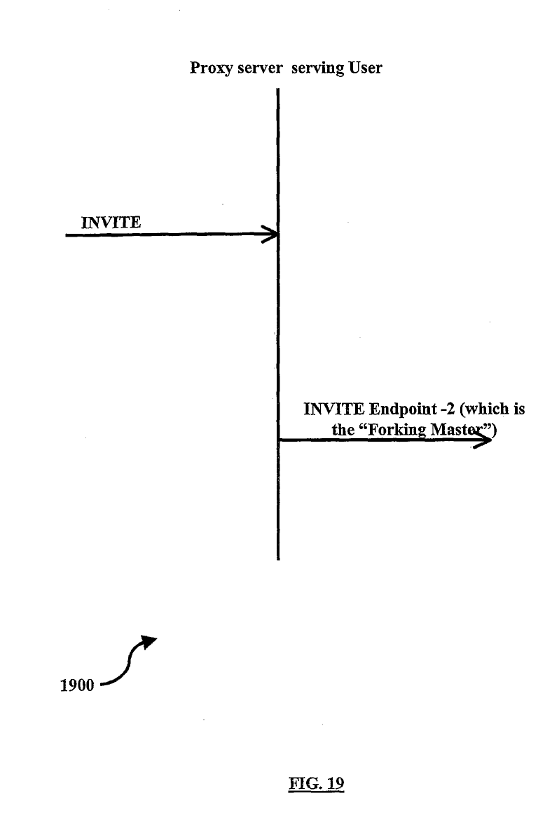

FIG. 19 is a schematic diagram showing an exemplary illustration of the use of Forking Master in a normal SIP network 201, according to an embodiment herein. The User has three endpoints with forking active. The Forking Master is endpoint 2 902 and is applicable for a service associated with the incoming request. Here, the INVITE request is sent only to endpoint 2 902 of the User A 301 after implementing the concept of Forking Master.

The embodiment disclosed herein enables the assignment of a Forking Master by provisioning. For example, a provisioned value of Forking Master is used only when no endpoint declares itself as Forking Master, the Forking Master is different depending on the time of the day, or the first Forking Master is not registered and a second endpoint automatically take over as the Forking Master, and the like. The provisioning in an IMS/SIP network includes updating of a web-interface by the user, sending an INVITE with a special service code, and the like. There are various possibilities if the provisioned Forking Master in the user profile is not currently registered. When services having interaction with Forking Master reaches the Forking Master, the network does not provide the requested service (or)the network does not perform any special functioning as there is no Forking Master available and the behavior is the same as in the case of the absence of the Forking Master concept. Also, the network may request for a new Forking Master to be assigned or to inform all the endpoints of the served user that there is no Forking Master currently assigned. If there is more than one command in the message body indicating forking-master=true, then the behavior may be implementation dependent such as ignore the message, take the first/last line in the message body as the valid Forking Master's identity and the like. Further, if the provisioned Forking Master (in the user profile) is currently not available (though registered), for example, when the Forking Master (e.g., a laptop) has crashed, then the network may attempt to contact other endpoints in the absence of Forking Master, after the retransmission rules of SIP are followed. This could result in a delay in sending a final response to the request to the calling user side, after the implementation of the Forking Master concept, as compared to the situation before implementing the Forking Master concept. However, such a situation is not likely to happen often, as the network is most likely to become aware of the availability of the Forking Master. Further, the advantages and the increased added value of implementing the Forking Master far outweighs the delay that is encountered rarely in responding (sending a final response) to an incoming request. The network may request for a new Forking Master to be assigned, or inform every endpoint of the served user that there is no Forking Master currently registered which in turn produce no impact in handling of the current request.

Embodiments disclosed herein allow a certain endpoint to assign another device of the same AoR as the Forking Master. The third-party assignment may be, for instance, if the to-be-assigned device does not support the extensions in SIP to convey the forking-master related information or if the current Forking Master wants to relinquish the role to another device forcibly. The third-party assignment of Forking Master can be done by sending an INVITE, or a MESSAGE request. The contact URI in the content of the SIP request is of the device acting as the Forking Master. In case of third-party assignment, additional aspects of the assigned device/endpoint may be considered before accepting the request to safeguard undesirable assignment of a certain endpoint as Forking Master. The third party assignment of Forking Master can be specified only for certain duration. Once the duration is expired, the default Forking Master defined in the user terminal performs the functions.

The embodiment disclosed herein provides an array of practical usage solutions. The Forking Master determines the endpoint to be monitored for the call completion services such as Call Completion to a Busy Subscriber (CCBS), Call Completion on No Reply (CCNR) and the like. In a case, if the called user has forking applicable and the Forking Master is busy and other terminals are not, then calls are forwarded normally and CCBS monitoring begins for the Forking Master. In another case, if the called user had forking applicable and the Forking Master as well as other terminals are busy, then CCBS monitoring would begin for Forking Master. The concept of Forking Master enables a calling user to book CCBS service to called users who has forking active resulting in completion of calls to the terminal desired by the calling user. The concept of Forking Master provides flexibility to the served user to indicate selective presence formation instead of per-terminal presence information. For example, a User is considered ‘on’ if his laptop is on in office hours and if the home PC is ‘on’ after office hours. Forking Master resolves the feature interaction ambiguities if the forking is active for a particular called user and one terminal is busy, another not responding and the called user has CFB, CFNR, SCF, etc active. For example, if the Forking Master (of this called user) is busy, and another terminal (of this called user) is not responding and CFB to User C and CFNR to User D is active for this called user, then CFB takes precedence in the present scenario and the call is forwarded to User C. The concept of Forking Master permits interception of a terminating party when a call is being intercepted and associates a Media server to the call in the presence of Forking. Personalized Ring Back Tone facility can be provided to the served user by referring to the Forking Master by deciding the location/endpoint and then associating the feature to calling party.

In the embodiment herein AS take up the function of assignment of Forking Master during user registration, subsequent declaration by the user, third-party assignment or network-driven assignment. The AS may be activated by the S-CSCF302 (driven by initial filter criteria or other) when the Contact header field in the REGISTER message contains the parameter forking-master, the user terminal declares the taking up/relinquishing its role of forking-master, and when a user terminal performs a third-party assignment of forking master. When the AS receives such an SIP request message, it updates the user profile regarding the Forking Masters indications and informs the HSS using the standard Sh interface of IMS and subsequently informs the terminating S-CSCF using the standard Cx interface of the update to the initial filter criteria arising out of the updates to the user profile related to the Forking Master. For network-triggered assignment, the network drive may be network or implementation dependent. As an example, the network has to drive the Forking Master assignment as there is no Forking Master provisioned in the user profile. Then, when the first endpoint sent a REGISTER message and the REGISTER reaches the AS, the AS initiates the assignment of Forking Master. The REGISTER or the INVITE message to query the identification of the Forking Master reach the AS, it sends appropriate responses to the User endpoints. Based on the initial filter criteria, the AS is involved in handling requests for a user for whom the Forking Master service is active. The URI of the called user is modified by the terminating AS to enhance the request to address only the Forking Master (instead of forking the request to all endpoints of called user). The requests to be modified so as to address only to forking master depends on implementation and service offering of a particular network operator.

Embodiments herein provide the capability to offer services or features that would be otherwise difficult to perform in the presence of forking due to complexity, resource usage or cost outweighing the benefit or the like. An endpoint that has the capability to understand the request but not able to perform the task->if this is known beforehand, then such a scenario can be rectified by the concept of Forking Master which also reduces error responses. The Forking Master concept is quite useful in situations where if all the endpoints react to the request then it leads to total confusion and the service will not function as expected. In situations where only one of the endpoints understand the requests, and the signaling traffic overhead is to be minimized then the endpoint can take over as Forking Master preventing the request sent to other endpoints (and receiving error responses, etc).

Embodiments herein provide availability status of the Forking Master which may be stored and actions can be triggered at the AS in the IMS network or proxy server in case of SIP network, based on the availability status of the Forking Master. The network triggering informs other endpoints the current identity and availability status of the Forking Master. Further, different default Forking Masters can be assigned in the user profile depending on the time of the day and/or service type. The message body for the assignment of Forking Master and the response to query by user terminal and the information of current Forking Master by the network is to be adapted/extended accordingly. The Application Server (in case of IMS networks) or the proxy server (in case of non-IMS SIP networks) implements the related functionality and the user profile data in HSS (in case of IMS networks) or the SIP Registrar (in case of non-IMS SIP networks) need to be suitably modified to support the requirement. The services using Forking Master can be provisioned at the network level. If the endpoint serving as Forking Master roams into another network then the network could trigger automatically another device taking over as Forking Master, and inform all endpoints of the user accordingly (or could also ask for a new assignment of Forking Master, by ‘network triggered assignment)

Embodiments herein provide exceptional cases illustrating the behavior of the Forking master in particular situations. If the Forking Master deregisters or if the registration times out, then the SIP Proxy in a (non-IMS) SIP network or the Application Server in an IMS network may send a request for the assignment of the new forking master. If the Forking Master does not respond for a received SIP request then the subsequent actions depend on the implementation and the type of the request (and hence the associated service). For example, if the Forking Master does not respond in a CCBS case, then an error response is sent in response to the SUBSCRIBE message requesting the CCBS booking. In a case, when an INVITE or some other SIP request message requests to assign a Forking Master (or an INVITE request is sent to query the current Forking Master's identity) but the proxy server in case of (non-IMS) SIP network or Application Server in case of IMS network does not support Forking Master concept, then a 501 Not implemented response is sent in response to the message. Further, if there is more than 1 line in the message body indicating forking-master=true, then such a message is ignored or the first or last line is taken as the valid Forking Masters identity (the option chosen is implementation dependent).

Embodiments disclosed herein add value when providing new/improved services/features and possibilities in the presence of forking in IMS/SIP networks across operators/vendors without any interoperability issues and in turn creates immense revenue generation potential. Operators can create of new/improved features using the proposed concepts, thereby enabling to differentiate themselves from the competitors, which, in turn, would lead to increase in revenues.

Embodiments disclosed herein further leads to convenience in many practical scenarios for the end-user. In case of an IP-based network, with SIP providing user as well as terminal mobility, the probability of a single user having multiple endpoints and with forking active may increase exponentially. The concept of Forking master provides the end-user the flexibility to enjoy a number of features, services, even in the presence of forking, and further to customize these to suit the individual convenience, for example, CCBS. Further, the concepts discussed here offer increased flexibility to use the proposed extensions without having to upgrade each of the endpoints, (for example, in the case of “third-party assignment”).

As can be appreciated, embodiments disclosed herein provide several new/improved services for IMS/SIP users based on the concept of Forking Master in the presence of forking. Also it is to be understood that the invention as described here is not limited to this precise embodiment and that various changes and modifications may be affected therein without departing from the original scope or spirit of present invention.

The list of structures corresponding to the claimed means is not exhaustive and that one skilled in the art understands that equivalent structures can be substituted for the recited structure without departing from the scope of the invention.

Embodiments disclosed herein can take the form of an entirely hardware embodiment, an entirely software embodiment or an embodiment including both hardware and software elements. The embodiments that are implemented in software include but are not limited to, firmware, resident software, microcode, etc.

The foregoing description of the specific embodiments will so fully reveal the general nature of the embodiments disclosed herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments disclosed herein have been described in terms of preferred embodiments, those skilled in the art will recognize that the embodiments disclosed herein can be practiced with modification within the spirit and scope of the appended claims.

What is claimed is:

1. A method of handling improved call services by assigning at least one endpoint as a Forking Master in a communication network, wherein said Forking Master provides improved call services for an Address of Record (AoR) in the request message in the presence of forking.

2. The method, as claimed in claim 1, wherein said Forking Master is assigned by a user.

3. The method, as claimed in claim 1, wherein said Forking Master is assigned by updating said user endpoint during registration.

4. The method, as claimed in claim 1, wherein said Forking Master is declared by said user endpoint, after registration using at least one of a INVITE and a MESSAGE.

5. The method, as claimed in claim 1, wherein said Forking Master is assigned by a third party using at least one of said INVITE and said MESSAGE.

6. The method, as claimed in claim 1, wherein said network triggers the assignment of said Forking Master, said method comprising steps of
said network sending said INVITE message to all user endpoints;
said user endpoints sending a response to said network, on receipt of said INVITE message;
said endpoints taking decisions regarding the assignment of said Forking Master.

7. The method, as claimed in claim 1, wherein said endpoint queries the identity of said Forking Master using at least one of REGISTER and said INVITE.

8. The method, as claimed in claim 1, wherein a communication network informs said Forking Master's identity using at least one of said INVITE and said MESSAGE to said endpoints.

9. The method, as claimed in claim 1, wherein a contact header field includes said parameter forking-master with an assigned value is included in at least one of a contact header field and a message body.

10. A system to handle improved call services in a communication network, wherein said system adapted to assign at least one endpoint as a Forking Master, wherein said Forking Master provides improved call services for an Address of Record (AoR) in the request message in the presence of forking.

11. The system, as claimed in claim 10, wherein said system comprises at least one means adapted to permit a user to assign said Forking Master using at least one of an INVITE and a MESSAGE.

12. The system, as claimed in claim 10, wherein said system comprises at least one means adapted to assign said Forking Master by updating said user endpoint during registration using at least one of an INVITE and a MESSAGE.

13. The system, as claimed in claim 10, wherein said system comprises at least one means adapted for declaring said Forking Master, after registration.

14. The system, as claimed in claim 10, wherein said system comprises at least one means adapted for a third party to assign said Forking Master.

15. The system, as claimed in claim 10, wherein said system comprises at least one means adapted for said network to trigger assignment of said Forking Master; said system further comprising at least one means adapted for
said network to send an INVITE message to all user endpoints;
said user endpoints to send a response to said network, on receipt of said INVITE message;
said endpoints to take decisions regarding the assignment of said Forking Master.

16. The system as claimed in claim 10, wherein said endpoint includes at least one means adapted to query said Forking Master's identity.

17. The system as claimed in claim 10, wherein said communication network informs said Forking Master's identity to said endpoints.

18. A mobile terminal, said terminal comprising at least one means adapted for
said terminal to act as a Forking Master;
said terminal to invite a second terminal to act as said Forking Master;
said terminal to query identity of said Forking Master; and
said terminal to relinquish role of said Forking Master.
